(19) United States
(12) Patent Application Publication
(10) Pub. No.: US 2007/0174764 A1
(43) Pub. Date: Jul. 26, 2007

(54) Data Collection

(75) Inventors: Asta J. Roseway, Redmond, WA (US); Carolyn J. Fuson, Redmond, WA (US); Melora Zaner-Godsey, Seattle, WA (US); Robert A. Farrow, Redmond, WA (US); Shari A. Tallarico, Redmond, WA (US); Tammy L. Savage, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,714

(22) Filed: Jan. 25, 2006

(51) Int. Cl. G06F 17/00; G06F 7/00; G06F 3/048

(52) U.S. Cl. 715/515; 707/102; 707/100; 715/530; 715/520; 715/764

(57) ABSTRACT

Data collection is described. A network-based data collection service enables users to define and manage data collections. Data items can be selected from any type of data source (e.g., a web page, a local document, an image file, an audio file, a video file, etc.) and added to a data collection. Data items may be any type of data (e.g., text, image, sound, video, etc.). A data collection may be shared by any number of users having various access permissions to the data collection. The data collection may also be viewed as a graphical presentation of each of the data items associated with the data collection such that each data item may be resized and/or repositioned within the graphical presentation.

### BACKGROUND

Computers and the Internet have given users access to vast amounts of very diverse data. For example, if a user is in the market to buy a new house, Internet searches can be done to help the user identify homes that are for sale. In addition to just knowing what homes are for sale, a user may also want other information to help in the home search. For example, additional searches may help the user find maps with driving directions to identified homes, research schools in various neighborhoods, research community activities and resources, and so on. As another example, a family planning a vacation may search many websites to research different possible vacation destinations. Once a destination is chosen, additional research may be done to identify the best options for hotel accommodations, airfare, rental car rates, and so on.

While the Internet is a great tool for finding data, aggregating the data that is found so that it can be easily reviewed and/or shared with others is a difficult task.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Data collection is described. A user may define a data collection to which any type of data items (e.g., text, video, image, sound, etc.) may be added. Metadata is also maintained for each data item within the data collection. Metadata may include a source from which the data item was selected, one or more user-entered annotations, global positioning system (GPS) data from a mobile device, presentation size data, and presentation position data. Data collections may be shared with multiple users such that any of the users with whom a data collection is shared may add data items and/or add annotations to data items. Various levels of access permissions may also be associated with users with whom a data collection is shared. A graphical presentation of the data collection may also be generated such that a user can view the data items with in the data collection. Furthermore, the graphical presentation may be generated such that a user may interactively modify the size and or position of one or more of the data items within the data collection.

### BRIEF DESCRIPTION OF THE DRAWINGS

FIG. 1 is a pictorial diagram that illustrates an exemplary data collection experience.

FIG. 2 is a pictorial diagram that illustrates an exemplary data collection display.

FIG. 3 is a pictorial diagram that illustrates an exemplary shared data collection experience.

FIG. 4 is a pictorial diagram that illustrates an exemplary display of a shared data collection.

FIG. 5 is a block diagram that illustrates an exemplary network environment in which data collection may be implemented.

FIG. 6 is a block diagram that illustrates select components of an exemplary client device configured to support data collection.

FIG. 7 is a block diagram that illustrates select components of an exemplary collections server configured to support data collection.

FIG. 8 is a flow diagram that illustrates an exemplary method for creating a data collection.

FIG. 9 is a flow diagram that illustrates an exemplary method for adding a data item to a data collection.

FIG. 10 is a flow diagram that illustrates an exemplary method for presenting a data collection.

FIG. 11 is a flow diagram that illustrates an exemplary method for sharing a data collection.

### DETAILED DESCRIPTION

Data collection as described below provides a mechanism by which diverse types of data from various sources can be aggregated to enable a user to view a collection of data. In addition, once the data is collected, it may be annotated and shared with others. The following discussion is directed to data collection. while features of data collection can be implemented in any number of different computing environments, they are described in the context of the following exemplary implementations.

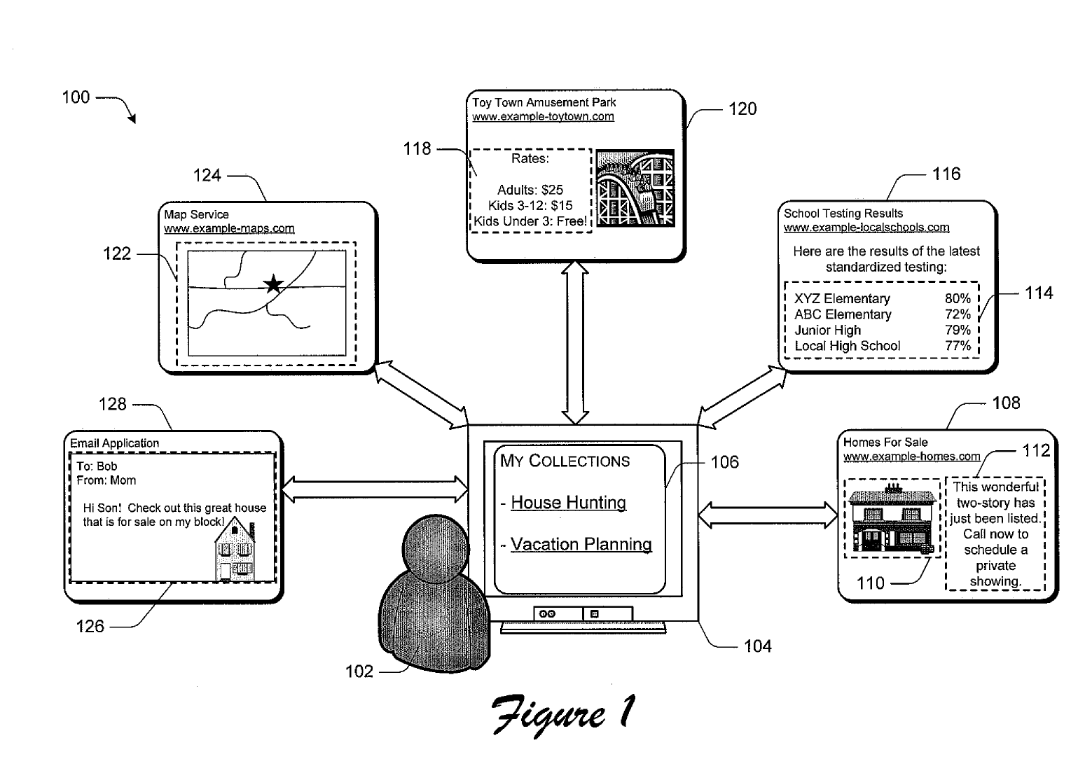

FIG. 1 illustrates an exemplary data collection experience. In the illustrated example, user 102 has access to various types of data through his computer system 104. A data collection application 106 identifies one or more data collections (e.g., a “House Hunting” collection and a “Vacation Planning” collection) that are currently available to the user.

In the illustrated example, data collection application 106 remains open while user 102 browses various websites (e.g., via a separate browser application). While perusing website 108, the user identifies an interesting home that is for sale. The user selects the picture of the home 110 and the associated description 112, and adds the selections to the house hunting collection. Adding a selection to a collection may be implemented in any number of ways, for example, the user may drag and drop the selection to the collection name shown in data collection application 106. Alternatively, the user may make the selection, right click a mouse, and select an “add to collection” item from an available menu.

The user may continue browsing websites, as illustrated in FIG. 1, adding text 114 from website 116 to the house hunting collection; adding text 118 from website 120 to the vacation planning collection; and adding image 122 from website 124 to the house hunting collection.

Data that can be added to a collection is not limited to data gathered from websites. For example, user 102 may select content 126 from an email message 128 to be added to the house hunting collection. Additionally, any type of data may be added to a collection, including, but not limited to, text, images, sound files, video files, and so on. Furthermore, data collections may be created locally, without requiring an Internet collection. In such an implementation, a local collection may maintain data gathered from local data sources, such as locally stored text files, images, email messages, and so on.

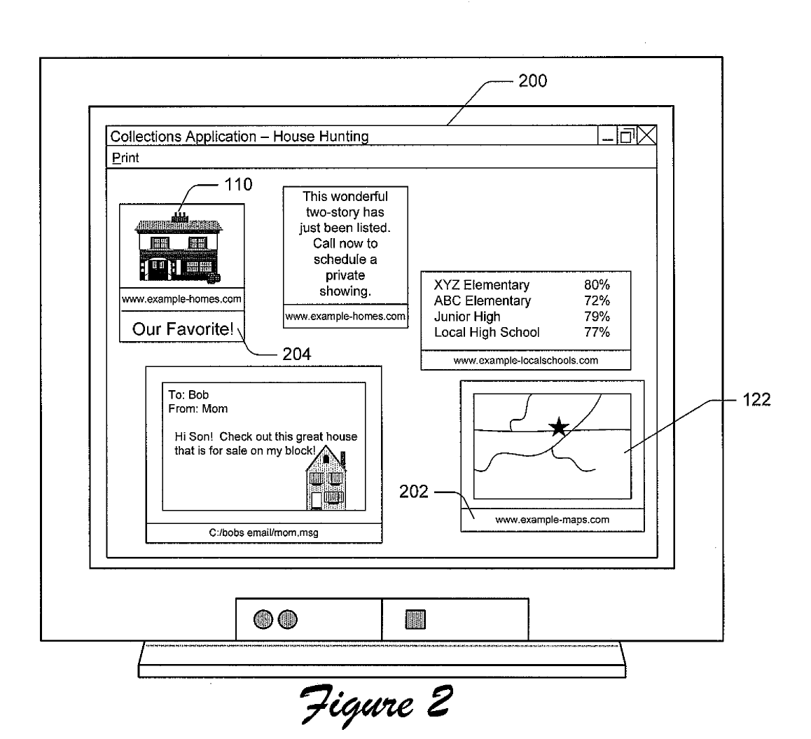

FIG. 2 illustrates an exemplary display of a data collection. In the illustrated example, user 102 has selected the house hunting collection through data collection application 106. The collection user interface (UI) 200 that is displayed includes the data that the user selected and added to the house hunting collection while browsing various websites and perusing email messages, as shown in FIG. 1. In addition for each data item added to the collection, a source of the item is also shown. For example, text area 202 includes the URL (uniform resource locator) associated with website 124 from which map image 122 was collected. In an exemplary implementation, selecting the URL in text area 202 causes a browser window to open with the website associated with the selected URL. Furthermore, text area 202 may also include a date and time that the item was added to the collection, and/or various other types of metadata that may be associated with the data item.

In addition to providing a presentation of a data collection, collection UI 200 also enables a user to modify the collection in various ways. For example, each item may be re-sized and arranged in any order or fashion within the collection UI 200. Furthermore, any number of annotations may be associated with each of the data items. For example, as shown in FIG. 2, a user has added a textual annotation 204 to image 110.

In addition to enabling a user to gather data from multiple sources for presentation as a collection, data collection application 106 also enables a user to share a collection. For example, a collection created by one user may be accessed via the Internet (or other type of network) by another user. In an exemplary implementation, the user who creates a data collection may specify one or more users with whom the collection is to be shared. Furthermore, the creator may also specify access levels to be granted to one or more of the users with whom the collection is to be shared. For example, some users may be granted access to view the collection, but not be allowed to add, modify, or delete annotations or data items. Similarly, other users may be granted fill access, allowing them to add or remove items or annotations as freely as the creator of the collection is allowed. Such sharing of data collections may be very useful in many different scenarios. For example, a shared data collection provides a central location where several individuals, who may be geographically distant from one another, can all contribute data to be used to plan a group vacation.

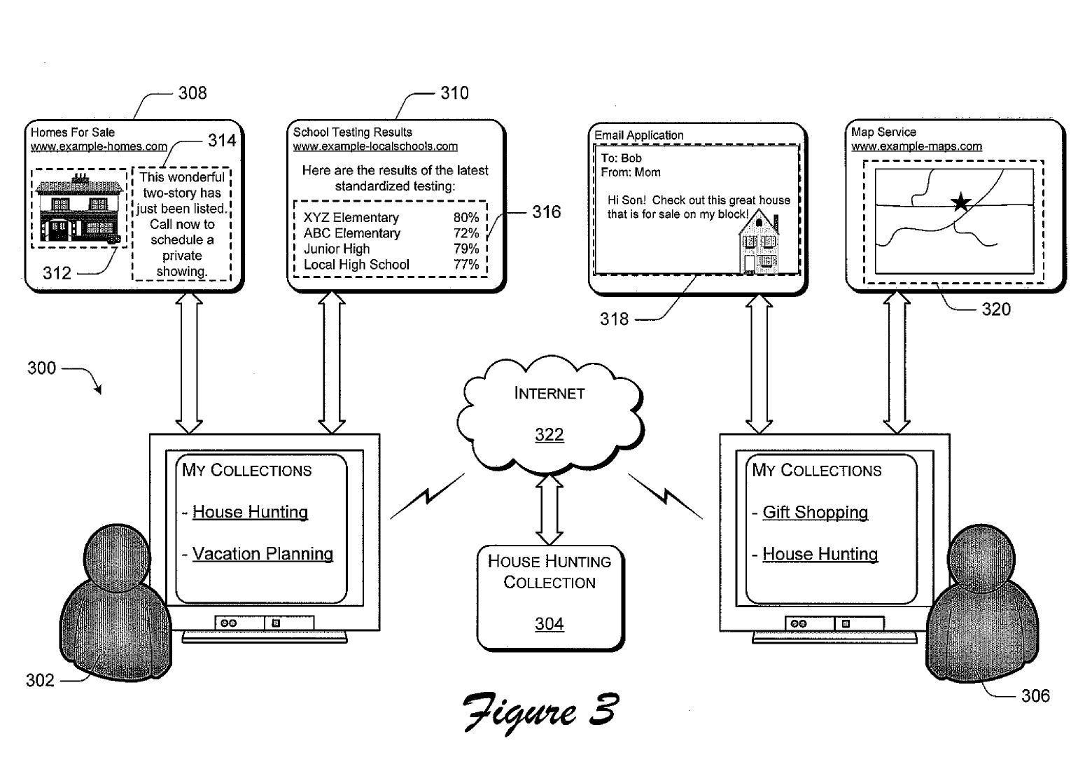

FIG. 3 illustrates an exemplary shared data collection experience. In the illustrated example, user 302 has created a house hunting collection 304, and has shared the collection with user 306. As illustrated in FIG. 3, user 302 browses websites 308 and 310, adding selected data items 312, 314, and 316 to the house hunting collection 304. Similarly, either simultaneously or at a different time, user 306 adds selected data items 318 and 320 to house hunting collection 304. Data associated with the shared collection 304 is available to both users via a network, such as the Internet 322.

Any number of techniques may be used to share data collections. For example, a user may choose to save a data collection to a web page or to a blog, which could then be viewed by others. Furthermore, data collections may be shared via a peer-to-peer network, email, various devices (e.g., mobile devices, televisions, gaming systems, etc.), and/or centralized storage.

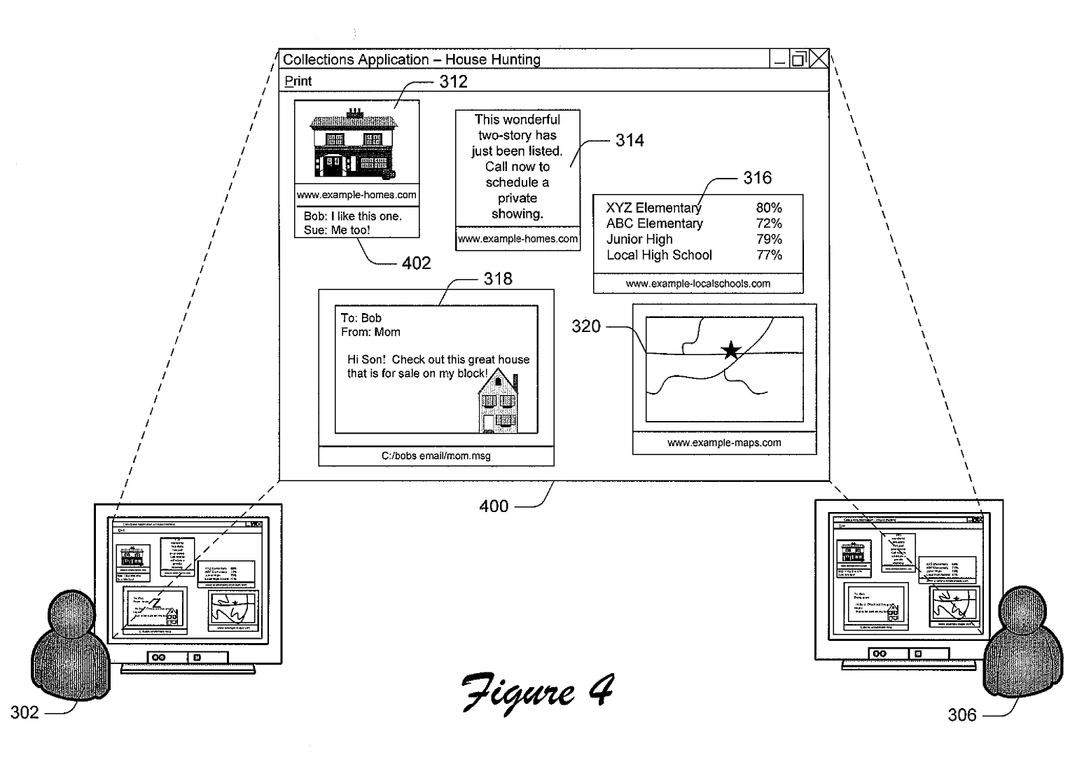

FIG. 4 illustrates an exemplary display of a shared data collection. Because the collection is shared, user 302 and user 306 are both able to access a display 400 of the collection, which, as shown, includes data collected by each of the users. As described above, annotations may be added to items within a collection. With a shared collection, each annotation may also be formatted to indicate which user with access to the collection added the annotation. For example, annotation 402 indicates that two users (i.e., Bob and Sue) have each added an annotation to data item 312.

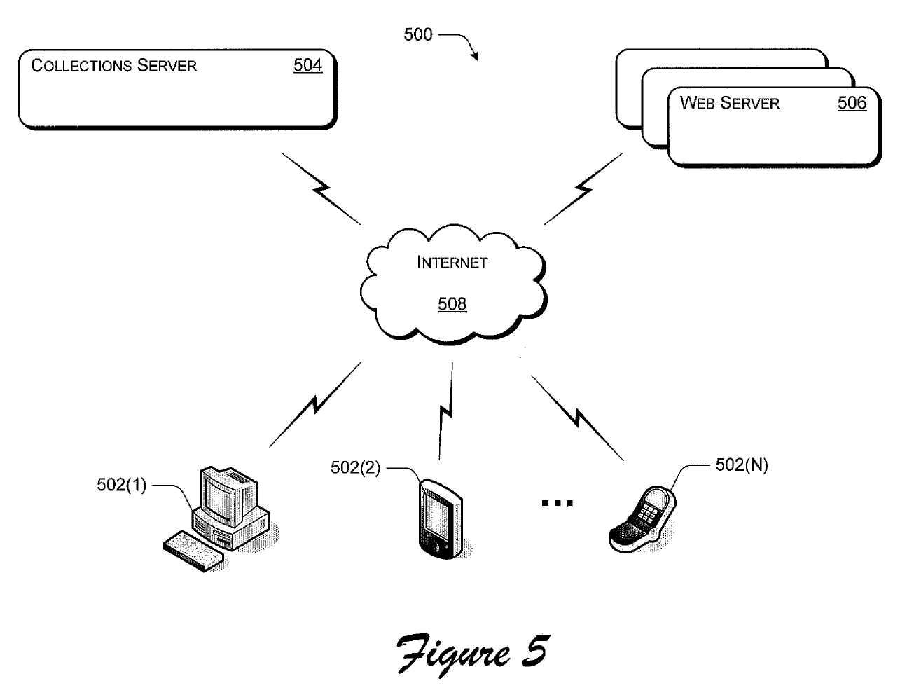

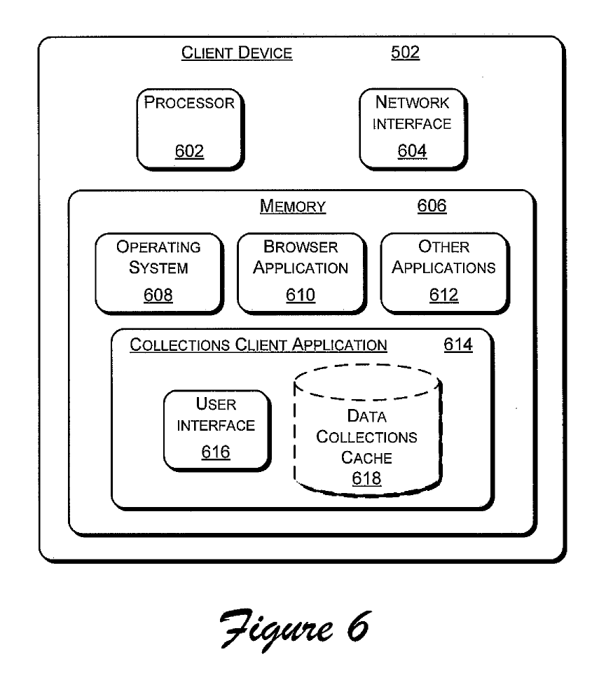

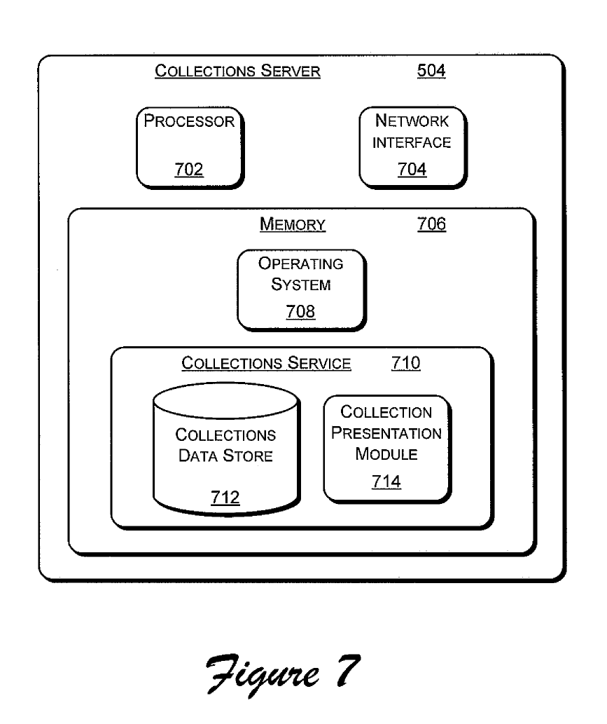

FIG. 5 illustrates an exemplary network environment 500 in which data collection as described herein may be implemented. Network environment 500 includes client devices 502(1), 502(2), . . . , 502(N), collections server 504, and one or more web servers 506. Client devices 502, collections server 504, and web servers 506 are configured to communicate via a network, such as the Internet 508. Each client device 502 enables a user to interact with collections server 504 to manage any number of user-defined data collections. As illustrated in FIG. 5, various types of client devices may be configured to support data collection as described herein. For example, client device 502(1) represents a personal computer; client device 502(2) represents an Internet-enabled personal digital assistant (PDA); and client device 502(N) represents an Internet-enabled cell phone (e.g., a smart phone). Any type of computing device may be configured as a client device to support data collection as described herein. As such, the client devices shown in FIG. 5 are merely examples of such computing devices, and are not intended as limitations. Select components of an exemplary client device are described in further detail below with reference to FIG. 6. Collections server 504 is configured to maintain user data collections and to manage user access to data collections. An exemplary collections server is described in further detail below with reference to FIG. 7. Web servers 506 may be implemented to provide web sites via the Internet 508. Web servers 506 are illustrated as example sources of data that may be gathered for inclusion within a data collection.

FIG. 6 illustrates select components of an exemplary client device 502 configured to support data collection as described herein. Client device 502 includes processor 602, network interface 604, and memory 606. Network interface 604 enables client device 502 to communicate with other devices such as collections server 504 and web servers 506 via a network such as the Internet 508. Operating system 608, browser application 610, other applications 612, and collections client application 614 are stored in memory 606 and executed on processor 602. Memory 606 is representative of any type or combination of memory, such as, but not limited to, random access memory (RAM), a hard disk, or removable memory media.

Browser application 610 provides a user interface through which data received from a web server 506 can be presented as a web page. Other applications 612 may include, for example, a word processing application, an email application, a spreadsheet application, and any other type of software application that may be stored in memory 606 and executed on processor 602.

In an exemplary implementation, collections client application 614 is implemented as a thin client that includes a user interface 616. In such an implementation, user interface 616 enables a user to create or delete collections, as well as to view, add, modify, and delete data in collections. In such an implementation, all of the data associated with the collections is stored on a collections server, which is accessed via the network. In an alternate implementation, collections client application 614 also includes data collections cache 618. Data collections cache 618 is configured to store data that identifies collections that are available to a user of client device 502. These may include collections that the user has defined and/or collections that other users have chosen to share with the user. In addition to an identification of available collections, data collections cache 618 may also be configured to maintain records indicating changes that are to be made to the available collections. For example, data collections cache 618 may include data that defines a new collection that the user is creating, data items that are to be added to one or more of the collections, annotations to be added to items in one or more of the collections, data that identifies a data item to be removed from a particular collection, and so on. In such an implementation, data may be uploaded from data collections cache 618 to a collections server periodically (e.g., every few minutes, every few hours, or once per day). Furthermore, data collections cache 618 may be implemented to support local collections, created to maintain data gathered locally, with no need for an Internet connection. In such an implementation, collections client application 614 may include one or more components illustrated in FIG. 7 as being part of collections server 504.

FIG. 7 illustrates select components of an exemplary collections server 504 configured to support data collection as described herein. Collections server 504 includes processor 702, network interface 704, and memory 706. Network interface 704 enables collections server 504 to communicate with other devices such as client device 502 via a network such as the Internet 508. Operating system 708 and collections service 710 are stored in memory 706 and executed on processor 702. Memory 706 is representative of any type or combination of memory, such as, but not limited to, random access memory (RAM), a hard disk, or removable memory media.

Exemplary collections service 710 includes collections data store 712 and collection presentation module 714. Collections data store 712 is configured to maintain data associated with one or more collections as defined by one or more users. For example, collections data store 712 may include data that defines a collection, as well as data items that are part of a defined collection. Collections data store 712 may also maintain metadata, such as a source (e.g., a URL or filename), an acquired date/time, GPS data (e.g., gathered from a mobile device used to access the collection), and one or more user-created annotations associated with data items. To support presentation of data collections to a user, collections data store 712 may also maintain, for each data item in a collection, a display size and a display location. The display size and the display location information may be utilized by collection presentation module 714 to format a collection for presentation to a user. For example, if a user requests (through collection client application 614) to view a particular collection, collection presentation module 714 queries collections data store 712 for all of the data items associated with the requested collection. The data items are then formatted for presentation to the viewer through collection client application user interface 616. By maintaining size and position data associated with each data item, if a user changes the presentation of the collection (e.g., by rearranging/resizing data items), those changes can be maintained.

In an alternate implementation, collections service 710 may provide a web-based user interface that enables users to create, manage, and share data collections. In such an implementation, no client application would need to be installed on the client device. Furthermore, collections service 710 may provide different user interfaces depending on how the service is being accessed. For example, one user interface may be configured for presentation via a personal computer while another user interface may be configured for presentation via a smaller mobile device.

Methods for data collection may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

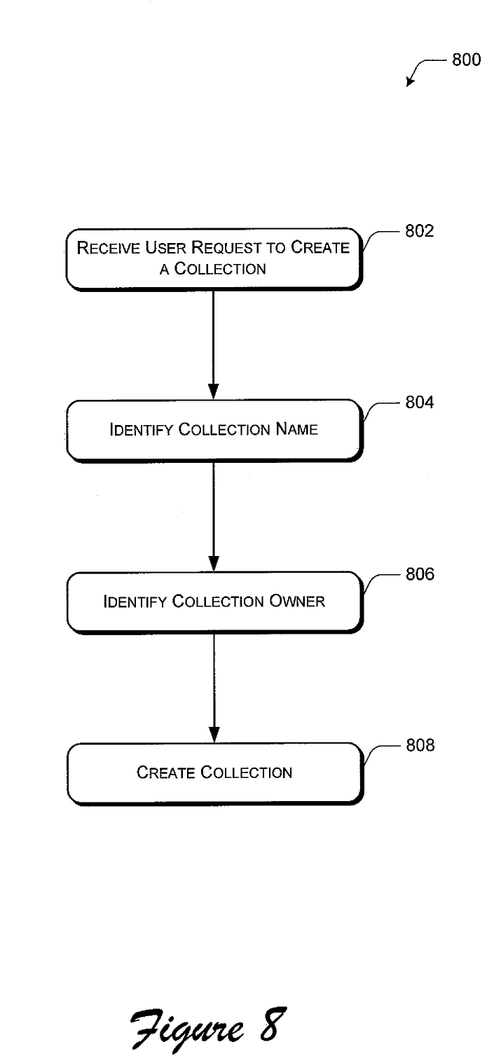

FIGS. 8-11 illustrate exemplary methods to support data collection as described herein. FIGS. 8-11 are specific examples of data collection, and are not to be construed as limitations. The order in which the methods are described is not intended to be construed as a limitation, and any number of the described method blocks can be combined in any order to implement the method. Furthermore, the methods can be implemented in any suitable hardware, software, firmware, or combination thereof.

FIG. 8 illustrates an exemplary method 800 for creating a data collection. At block 802, a user request to create a collection is received. For example, in an exemplary implementation, a user may submit a request to create a data collection via user interface 616. Alternatively, a user may submit a request to create a data collection via a web-based interface associated with collections service 710.

At block 804, a collection name is identified. For example, as part of the request to create a data collection, the user may specify a particular name to be associated with the data collection.

At block 806, a collection owner is identified. For example, the user submitting the request to create the collection may be identified (e.g., by a user ID) as the owner of the collection to be created.

At block 808, a new collection is created having the identified owner and the identified name. For example, a new record (or set of records) is written to collections data store 712, identifying the newly created data collection, the name of the collection, and the owner of the collection.

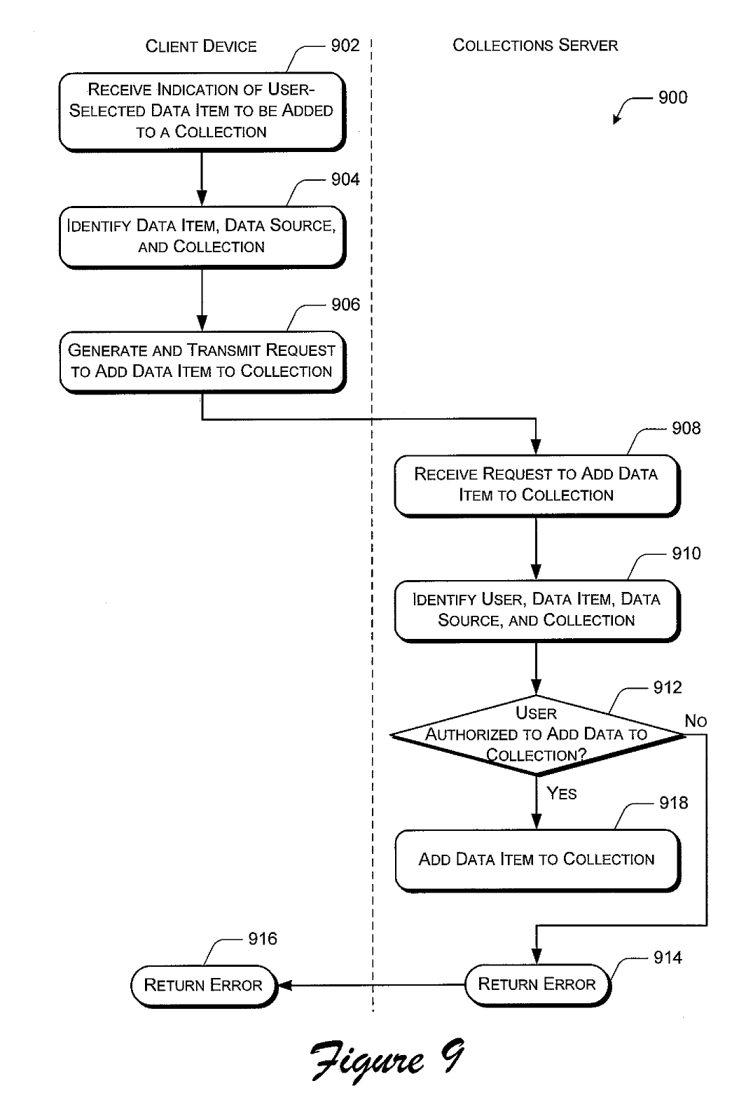

FIG. 9 illustrates an exemplary method 900 for adding a data item to a data collection. FIG. 9 includes blocks that represent processing that may be performed by a client device (e.g., client device 502) and blocks that represent processing that may be performed by a collections server (e.g., collections server 504). It is recognized, however, that various implementations are possible, and in some implementations, the described processing may be performed by a single computing system, or divided differently between multiple computing systems.

At block 902, a client device receives an indication of a user-selected data item to be added to a collection. For example, a user may select data from a website or other type of application, and indicate to collections client application 614 that the selected data is to be added to a particular collection.

At block 904, the client device identifies the data item, a data source, and a collection associated with the request. For example, collections client application 614 identifies the data item to be added to the collection, a source of the data item (e.g., a filename, a URL, or some other identifier), and an identifier associated with the collection to which the data item is to be added.

At block 906, the client device generates and transmits a request to add the data item to the collection. For example, collections client application 614 generates a request that includes information identifying the user, the data item, the source of the data item, and the collection to which the data item is to be added. Collections client application 614 transmits the request to collections service 710.

At block 908, a collections server receives a request to add a data item to a collection. For example, collections service 710 receives a request transmitted by collections client application 614.

At block 910, the collections server identifies a user associated with the request, the data item to be added to the collection, a source of the data item, and an identifier associated with the collection. For example, collections service 710 extracts this information from the received request.

At block 912, the collections server determines whether or not the user associated with the request is authorized to add data to the identified collection. For example, collections service 710 queries collections data store 712 to determine whether or not the user associated with the request is associated with the collection. If the user is identified as the owner of the collection, then the user is authorized to add data items to the collection. In the case of a shared collection, different users associated with the collection may have different permissions, so if the identified user is associated with the collection, but is not the owner of the collection, then the permissions associated with the user are queried to verify that the user is authorized to add data items to the collection.

If the identified user is not authorized to add data to the collection (the “No” branch from block 912), than at block 914, the collections server returns an error; and at block 916, the client device returns an error.

On the other hand, if the identified user is authorized to add data to the collection (the “Yes” branch from block 912), then at block 918, the item is added to the collection. For example, collections service 710 adds the data item to collections data store 712 such that the data item is associated with the specified collection. Furthermore, metadata including the source of the data item is also added to collections data store 712 such that the metadata is associated with the data item.

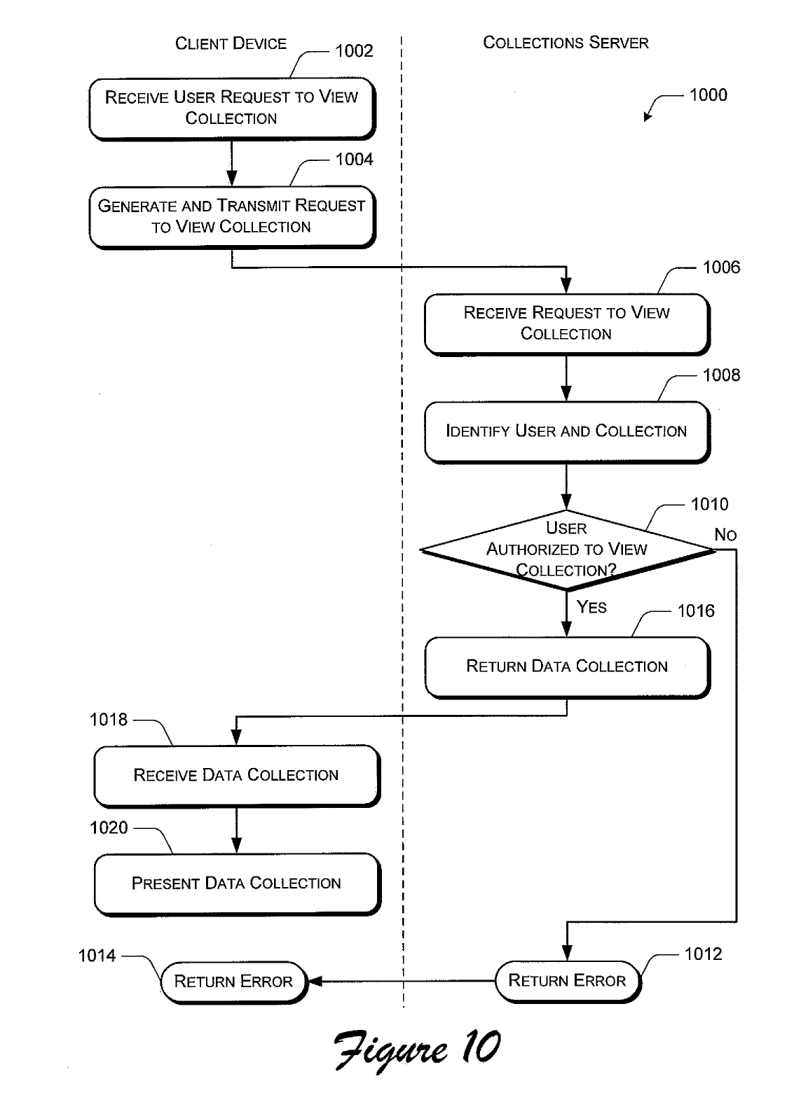

FIG. 10 illustrates an exemplary method 1000 for presenting a data collection. FIG. 10 includes blocks that represent processing that may be performed by a client device (e.g., client device 502) and blocks that represent processing that may be performed by a collections server (e.g., collections server 504). It is recognized, however, that various implementations are possible, and in some implementations, the described processing may be performed by a single computing system, or divided differently between multiple computing systems.

At block 1002, a client device receives a user request to view a collection. For example, a user may select a particular collection to be viewed via user interface 616.

At block 1004, the client device generates and transmits a request to view the collection. For example collections client application 614 generates a request that includes a user ID associated with the user and an identifier associated with the requested collection. The collections client application 614 transmits the request to collections server 304.

At block 1006, the collections server receives a request to view a collection. For example, collections service 710 receives a request transmitted from collections client application 614.

At block 1008, the collections server identifies a user and a collection associated with the request. For example, collections service 710 extracts this information from the received request.

At block 1010, the collections server determines whether or not the user associated with the request is authorized to view the identified collection. For example, collections service 710 queries collections data store 712 to determine whether or not the user associated with the request is associated with the collection, as either the owner of the collection, or as a user with whom the collection has been shared.

If the identified user is not authorized to view the data collection (the “No” branch from block 1010), than at block 1012, the collections server returns an error; and at block 1014, the client device returns an error.

On the other hand, if the identified user is authorized to view the data collection (the “Yes” branch from block 1010), then at block 1016, the collections server returns the data collection. For example, collection presentation module 714 queries collections data store 712 to identify the data items associated with the requested data collection. Collection presentation module 714 also generates a presentation layout for the data items. The presentation layout may be generated, for example, based on size and position metadata attributes associated with each of the data items. In an exemplary implementation, the first time a data item is included in a collection when a request to view the collection is received, initial size and position values are assigned to the data item. For example, the initial size value may be based on the original size of the data as found in the source of the data. The initial position value may be determined based on position values associated with other data items in the collection, such that when presented visually, the data item will not overlap any other data items in the collection.

At block 1018, the client device receives the data collection. For example, collections client application 614 receives the presentation layout of the data items from the collections server 504. In an alternate implementation, collection presentation module 714 may be implemented as part of collections client application 614, such that only the data items and their associated metadata are returned, and the client application generates the presentation layout.

At block 1020, the client device presents the data collection. For example, the presentation layout is presented via user interface 616.

FIGS. 9 and 10 each illustrate methods in which portions of the method are implemented by a client device and portions of the method are implemented by a collections server. It is recognized, however, that local collections may also be supported. In such an implementation, no processing is performed by a collections server, but rather, the method is implemented in its entirety by the client device.

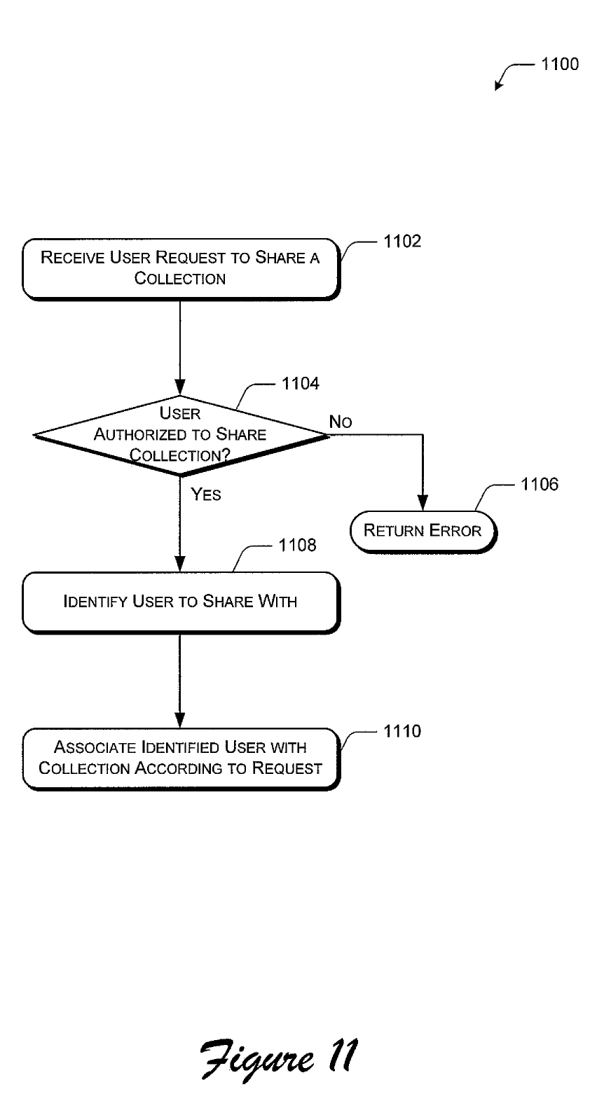

FIG. 11 illustrates an exemplary method 1100 for sharing a data collection. At block 1102, a user request to share a collection is received. For example, in an exemplary implementation, a user may submit a request to share a data collection via user interface 616. Alternatively, a user may submit a request to share a data collection via a web-based interface associated with collections service 710.

At block 1104, it is determined whether or not the user associated with the request is authorized to share the identified data collection. For example, collections service 710 queries collections data store 712 to determine whether or not the user associated with the request is associated with the collection. If the user is identified as the owner of the collection, then the user is authorized to share the collection. In the case of a collection that is already shared, different users associated with the collection may have different permissions, so if the identified user is associated with the collection, but is not the owner of the collection, then the permissions associated with the user are queried to verify that the user is authorized to share the collection with other users.

If it is determined that the requesting user is not authorized to share the data collection (the “No” branch from block 1104), then at block 1106 an error is returned.

On the other hand, if it is determined that the user is authorized to share the data collection (the “Yes” branch from block 1104), then at block 1108, a user with whom the collection is to be shared is identified. For example, a user ID associated with the user may be extracted from the received request.

At block 1110, the identified user is associated with the collection according to the received request. For example, collections service 710 adds data to collections data store 712 indicating that the identified user is now associated with the identified collection. Furthermore, the received request may specify specific permissions to be associated with the user for the data collection. If so, then these permissions are also specified in collections data store 712.

Although embodiments of data collection have been described in language specific to structural features and/or methods, it is to be understood that the subject of the appended claims is not necessarily limited to the specific features or methods described. Rather, the specific features and methods are disclosed as exemplary implementations of data collection.

1. A method, implemented at least in part by a computer, comprising:
receiving an indication of a user-selected data item to be added to a user-defined data collection; and
transmitting the user-selected data item to a collections server that maintains the data collection.

2. The method as recited in claim 1, wherein the user-selected data item comprises a selected portion of a source document, wherein the selected portion is less than the entire source document.

3. The method as recited in claim 1, wherein the data collection comprises a plurality of data items selected from a plurality of data sources.

4. The method as recited in claim 3, wherein each of the plurality of data items comprises at least one of text, an image, digital video data, or digital audio data.

5. The method as recited in claim 3, wherein each of the plurality of data sources comprises at least one of a web page, a word processing document, a spreadsheet, an email message, an audio file, an image file, or a video file.

6. The method as recited in claim 1, further comprising:
receiving a request to view the data collection; and
presenting a graphical display that includes a visual representation of each of a plurality of data items associated with the data collection, such that a position of each of the plurality of data items may be independently modified within the graphical display.

7. The method as recited in claim 6, wherein a size of the visual representation of each of the plurality of data items may be independently modified within the graphical display.

8. The method as recited in claim 6, wherein the visual representation of a particular one of the plurality of data items includes an indication of a source from which the data item was selected.

9. A data collection system comprising:
a network-based collections service configured to maintain user-defined data collections; and
a client application configured to enable a user to manage the user-defined data collections.

10. The system as recited in claim 9, wherein the collections service is further configured to manage user access to the data collections.

11. The system as recited in claim 9, wherein the collections service is further configured to generate a graphical presentation of data items associated with a particular one of the user-defined data collections.

12. The system as recited in claim 9, wherein the collections service comprises a collections data store configured to:
maintain user-defined data collections;
associate data items with the user-defined data collections; and
associate metadata with the data items.

13. The system as recited in claim 12, wherein the collections data store is further configured to maintain user access permissions associated with the data collections.

14. One or more computer-readable media comprising computer-readable instructions which, when executed, cause a computer system to:
receive a user request to create a data collection;
create a data structure that defines a data collection;
receive a request to add a user-selected data item to the data collection; and
add the data item to the data collection, such that the data item has associated metadata that identifies the source from which the data item was selected.

15. The one or more computer-readable media as recited in claim 14, wherein the data item is selected from a web page.

16. The one or more computer-readable media as recited in claim 14, wherein the data item comprises at least one of a selection of text, an image, a portion of a sound file, a representation of a sound file, a portion of a video file, or a representation of a video file.

17. The one or more computer-readable media as recited in claim 14, further comprising computer-readable instructions which, when executed, cause the computer system to:
receive a request to view the data collection; and
present a graphical display that includes a visual representation of the data item such that the visual representation of the data item may be resized within the graphical display.

18. The one or more computer-readable media as recited in claim 17, further comprising computer-readable instructions which, when executed, cause the computer system to present the graphical display that includes a visual representation of the data item such that the visual representation of the data item may be repositioned within the graphical display.

19. The one or more computer-readable media as recited in claim 14, further comprising computer-readable instructions which, when executed, cause the computer system to:
determine a first user identifier associated with the user; and
associate the first user identifier with the data collection to indicate that the user owns the data collection.

20. The one or more computer-readable media as recited in claim 19, further comprising computer-readable instructions which, when executed, cause the computer system to:
receive a request to share the data collection with another user;
determine a second user identifier associated with the other user with whom the data collection is to be shared; and
associate the second user identifier with the data collection to indicate that the other user has permission to access the data collection.
